(19) United States
(12) Patent Application Publication
(10) Pub. No.: US 2012/0202479 A1
(43) Pub. Date: Aug. 9, 2012

(54) OPERATION INFORMATION TRANSMISSION SERVER, OPERATION INFORMATION TRANSMISSION SYSTEM, AND OPERATION INFORMATION TRANSMISSION METHOD

(75) Inventors: Yasuyuki Sugitani, Tokyo (JP); Daisuke Enomoto, Tokyo (JP); Satoshi Fukutomi, Tokyo (JP)

(73) Assignee: DWANGO CO., LTD., Tokyo (JP)

(21) Appl. No.: 13/391,039

(22) PCT Filed: Jul. 6, 2011
(86) PCT No.: PCT/JP2011/065462

§ 371 Date: Feb. 17, 2012

(30) Foreign Application Priority Data
Jul. 6, 2010 (JP) 2010-154178
Dec. 28, 2010 (JP) 2010-293709

(51) Int. Cl. G06F 15/16; H04W 76/00

(52) U.S. Cl. 455/420; 709/217

(57) ABSTRACT

A first terminal device includes an input unit which inputs operation information indicating operation content, and a first transmission unit which transmits packet information including operation information input from the input unit and destination information for designating a second terminal device, which is a transmission target of the operation information among a plurality of terminal devices to an operation information transmission server. The operation information transmission server includes a first reception unit which receives the packet information transmitted from the first transmission unit and a second transmission unit which refers to the destination information included in the received packet information and transmitting the packet information addressed to the second terminal device corresponding to the destination information. The second terminal device receives the packet information transmitted from the second transmission unit, acquires the operation information from the packet information, and controls an operation corresponding to the operation information to be performed.

### CROSS REFERENCE TO RELATED APPLICATIONS

This is a U.S. national stage of application No. PCT/JP2011/065462, filed on 6 Jul. 2011. Priority under 35 U.S.C. §119(a) and 35 U.S.C. §365(b) is claimed from Japanese Application Nos. 2010-154178, filed 6 Jul. 2010 and 2010-293709, filed 28 Dec. 2010, the disclosure of which is also incorporated herein by reference.

### TECHNICAL FIELD

The present invention relates to an operation information transmission server, an operation information transmission system, and an operation information transmission method for remotely operating a terminal.

### BACKGROUND ART

Recently, the range of using mobile phones has widened and home electric appliances have also been equipped with functions for operating remotely. For example, in the following Patent Document 1, a mobile phone is connected to a data center via a network, and a control code corresponding to a device of a control target is downloaded. The control code is read and transmitted from the mobile phone to a target device by near field wireless communication such as infrared communication. Thereby, it is possible to remotely operate the device.

Incidentally, the mobile phone also has a function of outputting content such as sound, video, or text. To watch the content, a computer device may be connected to a network. A user may watch the content by use of both the mobile phone and the computer device.

### PRIOR ART DOCUMENT

### Patent Document

Patent Document 1: Japanese Unexamined Patent Application, Publication No. 2002-204292

### DISCLOSURE OF THE INVENTION

### Problems to be Solved by the Invention

When the content is viewed using a mobile phone or a computer device as described above, the computer device may be remotely operated using the mobile phone.

However, the computer device is not necessarily equipped with an infrared communication function or a near-field wireless communication function for receiving the control code. When the computer device is to be equipped with the infrared communication function or the near-field wireless communication function as described above, it is necessary to newly mount hardware capable of receiving a radio signal on the computer device.

The present invention has been made in view of the circumstances as described above, and an object of the invention is to provide an operation information transmission server, an operation information transmission system, and an operation information transmission method capable of remotely generating an instruction for a computer device, without newly installing hardware for receiving a radio signal.

### Means for Solving the Problems

According to an aspect of the present invention for solving the above-described problem, there is provided an operation information transmission server for use in an operation information transmission system in which a plurality of terminal devices, a content server which distributes content, and the operation information transmission server are connected via a network, the server including: a first receiving unit which receives packet information, which is transmitted from a first terminal device among the plurality of terminal devices and includes operation information indicating operation related to an output of content distributed from the content server; and a second transmission unit which transmits the operation information addressed to a second terminal device which outputs the content on the basis of the operation content indicating the operation information.

According to an aspect of the present invention, there is provided an operation information transmission system in which a plurality of terminal devices, a content server which distributes content, and an operation information transmission server are connected via a network, wherein a first terminal device of the plurality of terminal devices includes an input unit which receives an input of operation information indicating operation content related to an output of content distributed from the content server, and a first transmission unit which transmits packet information including the operation information of which the input is received by the input unit to the operation information transmission server, the operation information transmission server includes a first receiving unit which receives the packet information transmitted from the first transmission unit, and a second transmission unit which transmits the operation information addressed to a second terminal device, and the second terminal device includes a second receiving unit which receives the operation information transmitted from the second transmission unit; and a control unit which outputs the content on the basis of the operation content indicated by the operation information received by the second receiving unit.

According to an aspect of the present invention, in the above-described operation information transmission system, the content server which distributes the content is connected to the operation information transmission system, the content server includes a distribution unit which receives operation information and distributes a program and a content for implementing a function of performing an operation corresponding to the operation information according to a request from a terminal device; the second terminal device includes a playing unit, connected to the content server, for playing the content; and the control unit of the second terminal device outputs the content by executing the program.

According to an aspect of the present invention, in the above-described operation information transmission system, the first transmission unit of the first terminal device transmits the packet information to the operation information transmission server by generating destination information by use of login information input via the input unit, and the second transmission unit of the operation information transmission server transmits the operation information to a second terminal device corresponding to the destination information included in the packet information transmitted from the first transmission unit among logged-in second terminal devices in which login information has been input.

According to an aspect of the present invention, in the operation information transmission system, the input unit of the first terminal device inputs an instruction to the terminal device which designates an attribute of a user from a provider which provides the content, in addition to the input of the operation information, the first transmission unit of the first terminal device generates destination information for designating a second terminal device corresponding to the attribute input from the input unit as a transmission target, and the second transmission unit of the operation information transmission server transmits the operation information to the second terminal device of the user corresponding to the attribute according to the destination information in which the second terminal device corresponding to the attribute transmitted from the first terminal device is set as a target.

According to an aspect of the present invention, in the operation information transmission system, the first terminal device includes a storage unit which stores view history information indicating a history of content played in its own terminal device, and the first transmission unit of the first terminal device reads the view history information stored in the storage unit if a view history transmission instruction is input from the input unit, generates packet information in which the view history information is set as operation information, and transmits the generated packet information to the operation information transmission server.

According to an aspect of the present invention, in the operation information transmission system, the operation information transmission server includes: a storage unit which associates and stores transmission source identification information to be used when the first terminal device performs voice communication and transmission destination information, which is a destination to which transmission is performed by specifying a second terminal device owned by a user using the first terminal device; a transmission source identification information acquiring unit which acquires the transmission source identification information of the first terminal device from the first terminal device or a terminal device of a provider which provides the content; and a control unit which refers to the storage unit by acquiring the transmission source identification information, reads transmission destination information corresponding to the transmission source identification information, and transmits the operation information to the second terminal device through the second transmission unit according to the read transmission destination information.

According to an aspect of the present invention, in the operation information transmission system, the content server includes a determination unit which determines a member type of a user of the first terminal device, the distribution unit of the content server distributes a determination result of the determination unit to the first terminal device, the operation information is used to perform an operation of switching the member type according to the determination result transmitted from the content server, and the first transmission unit of the first terminal device transmits packet information including the operation information and destination information for designating a second terminal device, which is a transmission target of the operation information among the plurality of terminal devices, to the operation information transmission server.

According to an aspect of the present invention, in the operation information transmission system, the content server includes a determination unit which determines a member type of a user of the first terminal device, the operation information is used to perform an operation of switching the member type according to the determination result, and the distribution unit of the content server transmits packet information including the operation information and destination information for designating a second terminal device, which is a transmission target of the operation information among the plurality of terminal devices, to the operation information transmission server.

According to an aspect of the present invention, in the operation information transmission system, the second receiving unit of the second terminal device receives the packet information transmitted by the second transmission unit of the operation information transmission server, and the control unit of the second terminal device is connected to a user information management server which switches a member type of the user, according to the packet information received by the second receiving unit.

According to an aspect of the present invention, there is provided an operation information transmission server for use in an operation information transmission system in which a plurality of terminal devices, a content server which distributes content, and the operation information transmission server are connected via a network and a plurality of terminal devices are connected to the network, the server including: a first receiving unit which receives packet information including operation information, which is input from an input unit of a first terminal device among the plurality of terminal devices and indicates operation content related to an output of content distributed from the content server; and a second transmission unit which transmits the operation information addressed to a second terminal device which outputs the content on the basis of the operation content indicating the operation information.

According to an aspect of the present invention, there is provided an operation information transmission method of an operation information transmission server for use in an operation information transmission system in which a plurality of terminal devices, a content server which distributes content, and the operation information transmission server are connected via a network, the method including: receiving, by a first receiving unit, packet information, which is transmitted from a first terminal device among the plurality of terminal devices and includes operation information indicating operation content related to an output of content distributed from the content server; and transmitting, by a second transmission unit, the operation information addressed to a second terminal device, which outputs the content on the basis of the operation content indicating the operation information.

According to an aspect of the present invention, there is provided an operation information transmission method for use in an operation information transmission system in which a plurality of terminal devices, a content server which distributes content, and an operation information transmission server are connected via a network, the method including: inputting, by an input unit of a first terminal device of the plurality of terminal devices, operation information indicating operation content related to an output of content transmitted from the content server; transmitting, by a first transmission unit of the first terminal device, packet information including the operation information input from the input unit to the operation information transmission server; receiving, by a first receiving unit of the operation information transmission server, the packet information transmitted from the first transmission unit; transmitting, by a second transmission unit of the operation information transmission server, the operation information addressed to a second terminal device; receiving, by a second receiving unit of the second terminal device, the operation information transmitted from the second transmission unit; and outputting, by a control unit of the second terminal device, the content on the basis of the operation content indicated by the operation information received by the second receiving unit.

According to an aspect of the present invention, there is provided an operation information transmission method of an operation information transmission server for use in an operation information transmission system in which a plurality of terminal devices, a content server which distributes content, and the operation information transmission server are connected via a network and a plurality of terminal devices are connected to the network, the method including: receiving, by a first receiving unit, packet information including operation information, which is input from an input unit of a first terminal device among the plurality of terminal devices and indicates operation content related to an output of content distributed from the content server; and transmitting, by a second transmission unit, the operation information addressed to a second terminal device, which outputs the content on the basis of the operation content indicating the operation information.

### EFFECTS OF THE INVENTION

According to the present invention as described above, an operation information transmission server connected via a network distributes operation content input from a first terminal device to another terminal device, and the terminal device receiving the operation content performs a process corresponding to the operation content. Thereby, it is possible to remotely generate an instruction for a computer device without newly providing hardware for receiving a radio signal in the computer device.

### BRIEF DESCRIPTION OF THE DRAWINGS

FIG. 1 is a schematic block diagram showing a configuration of an operation information transmission system according to an embodiment of the present invention.

FIG. 2 is a block diagram showing a configuration of a distributor terminal according to an embodiment of the present invention.

FIG. 3 is a block diagram showing a configuration of a content server according to an embodiment of the present invention.

FIG. 4 is a block diagram illustrating a configuration of a mobile phone according to an embodiment of the present invention.

FIG. 5 is a block diagram illustrating a configuration of an operation information server according to an embodiment of the present invention.

FIG. 6 is a block diagram illustrating a configuration of a user terminal according to an embodiment of the present invention.

FIG. 7 is a flowchart illustrating an operation of the mobile phone according to an embodiment of the present invention.

FIG. 8 is a diagram showing an example displayed on a screen of the mobile phone according to an embodiment of the present invention.

FIG. 9 is a diagram showing an example displayed on a screen of the mobile phone according to an embodiment of the present invention.

FIG. 10A is a diagram showing an example displayed on a screen of the mobile phone according to an embodiment of the present invention.

FIG. 10B is a diagram showing an example displayed on a screen of the mobile phone according to an embodiment of the present invention.

FIG. 11 is a flowchart illustrating an operation of the operation information transmission server according to an embodiment of the present invention.

FIG. 12 is a flowchart illustrating an operation of a user terminal according to an embodiment of the present invention.

FIG. 13 is a diagram showing an example of content displayed on a screen of the user terminal according to an embodiment of the present invention.

FIG. 14 is a diagram showing an example of information stored in a storage unit according to an embodiment of the present invention.

FIG. 15 is a diagram showing an example of a screen when content is displayed on the screen of the mobile phone or the user terminal according to an embodiment of the present invention.

FIG. 16 is a diagram illustrating a function of the mobile phone according to an embodiment of the present invention.

FIG. 17A is a diagram showing an example of a screen displayed on the user terminal according to an embodiment of the present invention.

FIG. 17B is a diagram showing an example of a screen displayed on the user terminal according to an embodiment of the present invention.

FIG. 18 is a diagram showing an example of information stored in a storage unit according to another embodiment of the present invention.

FIG. 19 is a diagram showing an example of user registration information stored in the storage unit according to an embodiment of the present invention.

FIG. 20 is a schematic block diagram showing a configuration of an operation information transmission system according to another embodiment of the present invention.

FIG. 21 is a block diagram showing a configuration of a content server according to an embodiment of the present invention.

FIG. 22 is a block diagram illustrating a configuration of a user terminal according to an embodiment of the present invention.

FIG. 23 is a block diagram illustrating a configuration of a mobile phone according to an embodiment of the present invention.

FIG. 24 is a sequence diagram showing an example of an operation information transmission system according to another embodiment of the present invention.

FIG. 25 is a diagram showing an example of a selection screen displayed on the mobile phone according to an embodiment of the present invention.

FIG. 26 is a sequence diagram showing an example of an operation information transmission system according to another embodiment of the present invention.

### EMBODIMENTS FOR CARRYING OUT THE INVENTION

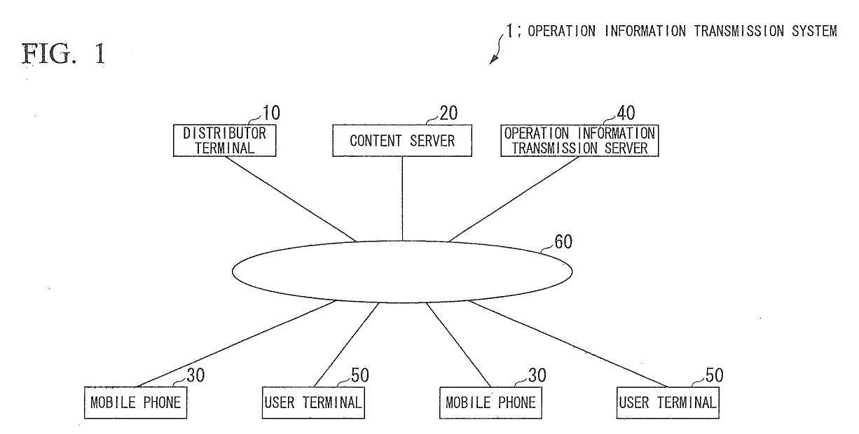

Hereinafter, an operation information transmission system according to an embodiment of the present invention will be described with reference to the drawings. FIG. 1 is a schematic block diagram showing a configuration of the operation information transmission system according to an embodiment of the present invention.

In the operation information transmission system 1, a distributor terminal 10, a content server 20, a mobile phone 30, an operation information transmission server 40, and a user terminal 50 are connected via a network 60. The network is configured to include a communication network in which the user terminal 50 and the mobile phone 30 of an Internet network, a public network, or the like are communicable. The mobile phone 30 is an example of a first terminal device, and the user terminal 50 is an example of a second terminal device.

Here, when the user terminal 50 and the mobile phone 30 need not be particularly differentiated in the following embodiments, the user terminal 50 and the mobile phone 30 are referred to as “terminals.”

An operation of the operation information transmission system 1 will be schematically described. A distributor that distributes content creates the content by use of the distributor terminal 10, and distributes the created content to the content server 20 along with a content distribution request. The content may be created by the mobile phone 30 or the user terminal 50 rather than the distributor terminal 10.

Upon receipt of the distribution request, the content server 20 distributes distribution-requested content to a terminal requesting the content distribution. If a comment is input from a user who is watching content via the user terminal 50 or the mobile phone 30, the content server 20 receives the comment and distributes the received comment along with content addressed to another terminal on which the same content is being watched.

As the distributed content, a live video distributed from the distributor terminal 10 may be distributed to each terminal requesting the distribution in real time. Content stored once in the content server 20 may be distributed in a streaming type when the content server 20 receives a distribution request from the terminal. Thereby, it is possible to perform communication with the comment while the same content is shared between a plurality of users.

In this embodiment, a user can watch content using a plurality of terminals. For example, the user has one user terminal 50 and one mobile phone 30. While video or audio content is played and watched on the user terminal 50, it is possible to input a comment for the content by use of the mobile phone 30 and transmit the comment to the content server 20. The user can operate the user terminal 50 using the mobile phone 30 from a remote location. For example, it is possible to remotely operate the user terminal 50 without directly operating the user terminal 50 by receiving a command for turning up a sound volume of content to be played by the user terminal 50 from the mobile phone 30 and transmitting the received command to the user terminal 50 via the operation information transmission server 40.

Next, each part of the operation information transmission system 1 will be further described.

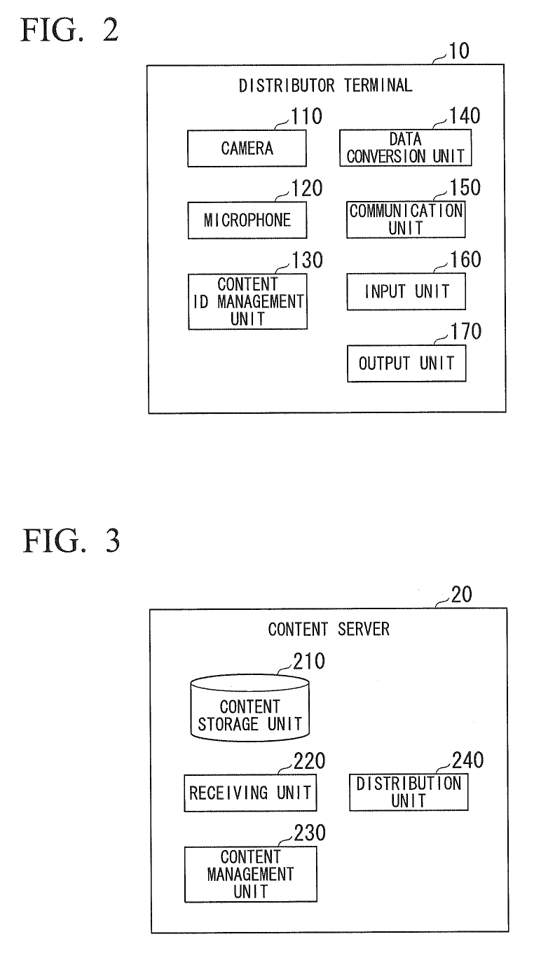

FIG. 2 is a block diagram showing a configuration of the distributor terminal 10. The distributor terminal 10 is used by a distributor who distributes a live video. The distributor is a person who appears in the content (program) of the live video, or a group or an individual serving as a subject of distribution, and is, for example, a performer such as a presenter, an entertainer, an actor, or an actress.

In the distributor terminal 10, a camera 110 shoots a target. Here, for example, a performer who appears in the live video, i.e., the content is shot. A microphone 120 detects a sound within a studio where a real-time video is shot. Here, for example, the performer's voice is detected within the studio.

A content ID management unit 130 generates a content ID for identifying content to be distributed by the distributor terminal 10. Each program can be identified by the content ID.

A data conversion unit 140 converts video data shot by the camera 110, audio data detected by the microphone 120, and the content ID generated by the content ID management unit 130 into communicable data.

A communication unit 150 has a function of distributing audio or video data after a conversion by the data conversion unit 140 to the content server 20 as content and a function of communicating with each terminal and the operation information transmission server 40.

An input unit 160 is an input device such as a keyboard or a mouse. For example, it is possible to add text data or the like to content according to an input instruction from the distributor. An example of an output unit 170 is a liquid crystal display (LCD) device or a speaker, which outputs generated content.

FIG. 3 is a block diagram showing a configuration of the content server 20. In the content server 20, a content storage unit 210 stores comment information associated with text information that is a comment for every piece of comment identification information for identifying a comment transmitted from the user terminal 50 or the mobile phone 30. Here, the comment storage unit 210 may include a comment storage area (thread) different for each piece of content (each program) to be distributed to the user terminal 50 or the mobile phone 30. A plurality of threads may be provided for one piece of content.

A receiving unit 220 receives comment information transmitted from each terminal (the user terminal 50 or the mobile phone 30), and stores the received comment information in the comment storage unit 210. A comment management unit 230 additionally stores the additional comment information received by the receiving unit 220 from each terminal in the comment (information) storage unit 210 according to a content ID and a thread ID.

Upon receipt of a distribution request of content designated by the content ID from the terminal, a distribution unit 240 transmits content corresponding to the content ID to a terminal of a request source. A content distribution method is performed, for example, by streaming distribution.

The distribution unit 240 reads comment information corresponding to a distribution-requested content ID from the comment storage unit 210, and transmits the read comment information to a terminal requesting the distribution.

The distribution unit 240 distributes an operation information transmission program for implementing a function for watching content according to the distribution request from the terminal. The operation information transmission program implements a function of transmitting packet information (to be described later) to another terminal according to execution or a function of receiving packet information transmitted from another terminal and performing an operation corresponding to operation information included in the packet information. Here, the packet information includes operation content input from a terminal device and is transmitted to a terminal device by way of the operation information transmission server 40.

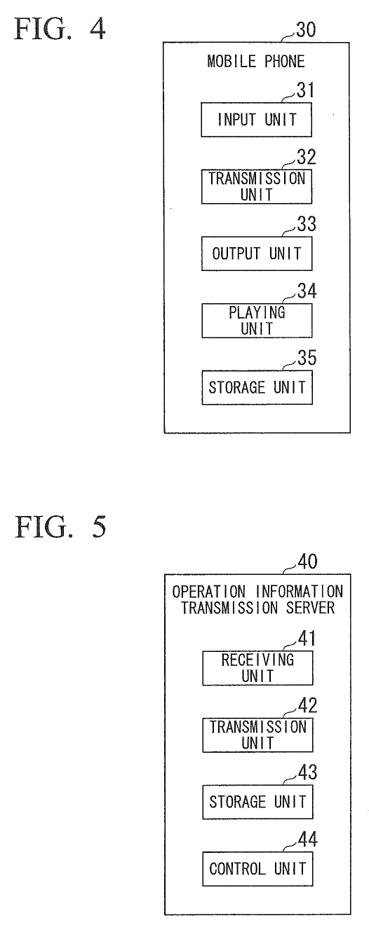

FIG. 4 is a block diagram illustrating a configuration of the mobile phone 30.

An example of an input unit 31 is an input device such as a keyboard or a touch panel, which inputs operation information indicating operation content corresponding to the user's operation. The user's voice may be input using a microphone as the input unit 31, so that the input voice can be converted into text and operation information can be input by analyzing its content. An example of the operation information is an operation of switching content being played in another terminal to other content, an operation of turning up or down a sound volume of content, an operation of inputting a comment, when content being played by another terminal is a game, an operation of an instruction capable of being input in a game, a search result, or the like. It is possible to input text, an image, or a sound as the comment. The input unit 31 has a function of inputting a login ID or a password necessary to authenticate a user using a content playing service according to the user's instruction.

A transmission unit 32 transmits packet information including operation information input from the input unit 31 and destination information designating a terminal that is a transmission target of the operation information among a plurality of terminals to the operation information transmission server 40. In addition, the transmission unit 32 generates the destination information using login information input via the input unit 31, and transmits the packet information to the operation information transmission server 40. An example of an output unit 33 is an LCD device or an audio output device such as a speaker, which displays an image of received content or outputs a sound. A playing unit 34 plays content received from the content server 20, so that the output unit 33 outputs the played content. A storage unit 35 stores various information. In addition, although not shown, the mobile phone 30 also has a function of performing voice communication as mobile communication.

FIG. 5 is a block diagram illustrating a configuration of the operation information transmission server 40.

A receiving unit 41 receives packet information transmitted from the transmission unit 32 of the mobile phone 30.

A transmission unit 42 refers to destination information included in the received packet information, and transmits the packet information to a terminal corresponding to the destination information. Here, when a login ID is designated as the destination information, the transmission unit 42 designates the user terminal 50 logged in by a login ID corresponding to the login ID, and transmits the packet information addressed to the user terminal 50 in a multicast mode. Thereby, only the user terminal 50 consistent with the login ID among terminals receiving the packet information acquires the packet information, and performs a control operation corresponding to operation information.

Here, as a method of specifying a user terminal corresponding to a login ID, for example, if the same user uses a plurality of terminals when the user is registered, a terminal ID registered for each terminal is acquired and stored in a predetermined storage area as user information by associating terminal IDs of the same user with the login ID. If a login ID is designated as destination information from a certain terminal, its storage area is referred to, a terminal ID corresponding to the login ID is read, and the terminal ID is distributed as a destination of a target to which the packet information is transmitted.

Here, if the user is not pre-registered when the login ID is issued, for example, when a content distribution request is received from the mobile phone 30 or the user terminal 50, a one-time virtual login ID is issued and stored in association with information for identifying a terminal of the mobile phone 30 or the user terminal 50. Thereby, the association can be performed.

The storage unit 43 stores various information. A control unit 44 performs various control operations within the operation information transmission server 40.

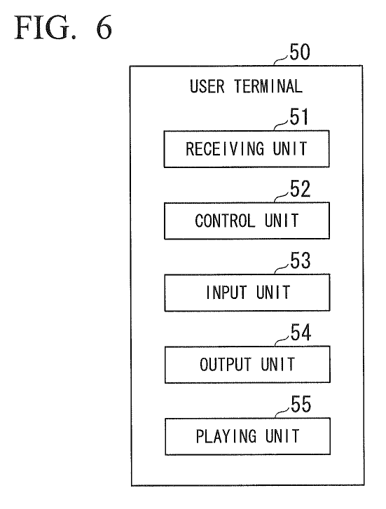

FIG. 6 is a block diagram illustrating a configuration of the user terminal 50. An example of the user terminal 50 is a computer device.

A receiving unit 51 receives packet information transmitted from the transmission unit 32 of the mobile phone 30.

A control unit 52 extracts operation information from the packet information received by the receiving unit 51, and controls the user terminal 50 by performing an operation corresponding to the operation information. A function to be performed by the control unit 52 may be pre-installed in the user terminal 50 or may be implemented by extracting an operation information transmission program downloaded along with content from the content server 20.

An input unit 53 is an input device such as a keyboard or a mouse. An output unit 54 is an audio output device such as a speaker or an LCD device. A playing unit 55 downloads and plays content by connecting to the content server 20, so that the played content is output by the output unit 54.

Next, an operation of the operation information transmission system 1 in the above-described configuration will be described.

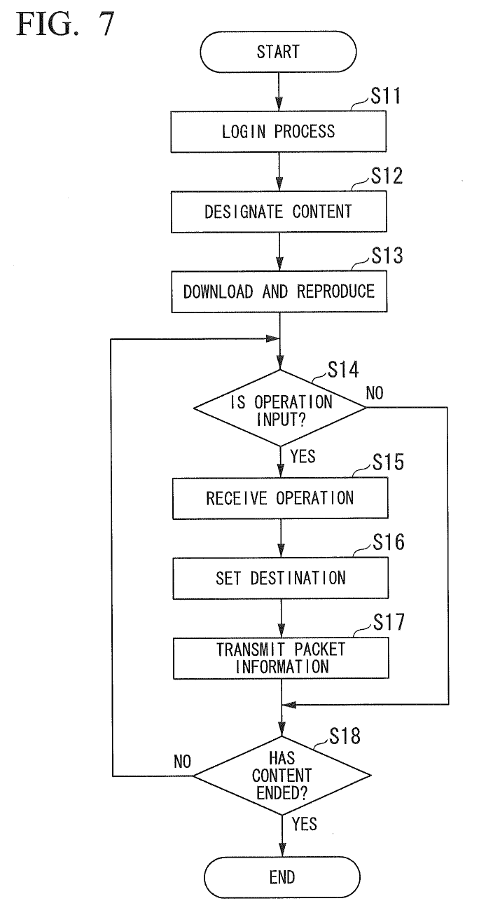

FIG. 7 is a flowchart illustrating an operation of the mobile phone 30. Here, the distributor terminal 10 distributes content to the content server 20, so that a state in which content can be distributed from the content server 20 to each terminal is reached.

First, when accessing the content server 20 according to an instruction from the user, the mobile phone 30 performs a login process (step S11). Here, a screen to which a login ID and a password are input is displayed on the display unit 33. If the user inputs the login ID and the password via the input unit 31, the mobile phone 30 transmits the login ID and the password to the content server 20 and receives an authentication result from the content server 20. If the login ID and the password are consistent with those pre-registered by the user, the authentication is established and information of a screen for selecting content to be watched is distributed from the content server 20.

If the user designates content of a target to be watched via the input unit 31 (step S12), the mobile phone 30 transmits a content ID corresponding to the designated content to the content server 20. Accordingly, content corresponding to the content ID and an operation information transmission program are downloaded from the content server 20 to the mobile phone 30, the content is played, and the operation information transmission program is executed (step S13).

After the operation information transmission program has been executed, the user can input operation information while watching the content. The mobile phone 30 determines whether or not the user has input the operation information via the input unit 31 (step S14). Here, operation content (a turning up or down of the sound volume by 1, or the like) is assigned to each button of a numeric keypad of the mobile phone 30. The operation content assigned to the button is detected if any one button is pressed (step S15), a login ID input in step S11 is associated with the operation content as destination information (step S16), and a result of association is transmitted to the operation information transmission server 40 as packet information (step S17). A transmission destination is included in the operation information transmission program.

If no operation is input within a fixed time or after the packet information has been transmitted, the mobile phone 30 determines whether or not the playing of content has ended (step S18). The process proceeds to step S14 if the content playing has not ended and an output of the content ends if the content playing has ended.

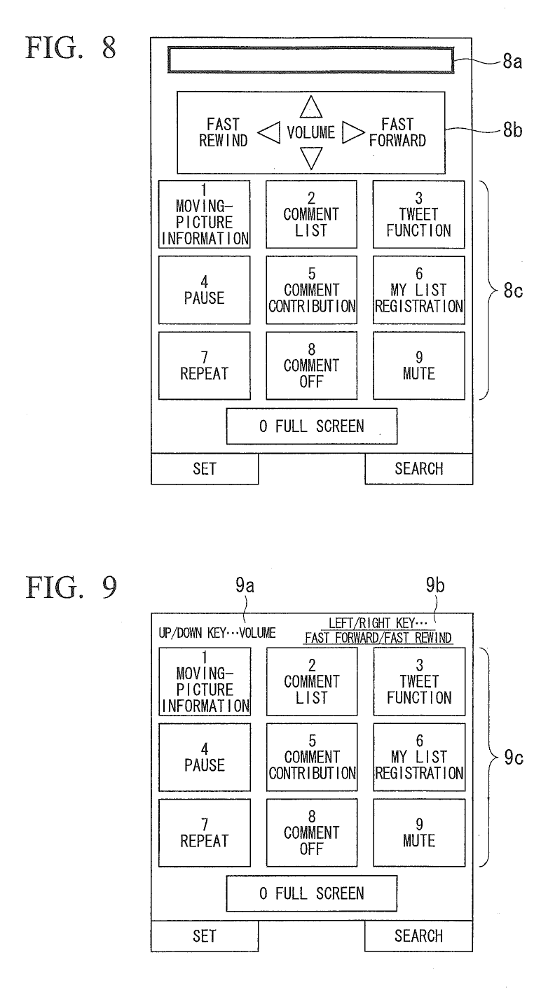

FIG. 8 is a diagram showing an example when operation content assigned to buttons of the input unit 31 of the mobile phone 30 is associated with the button and displayed on a screen. In this drawing, a title of the content is displayed in a display field indicated by reference numeral 8a. Functions assigned to arrow-keypad buttons (up, down, left, and right) of the input unit 31 are displayed in a display field indicated by reference numeral 8b. Here, for example, information indicating the up arrow of the arrow-keypad button assigned for a turning sound volume up, the down arrow assigned for a turning sound volume down, the left arrow assigned for fast rewind of content, and the right arrow assigned for fast forward of content is displayed.

Button functions assigned to the numeric keypad of the input unit 31 are displayed in a display field indicated by reference numeral 8c. Here, for example, a function of displaying moving-image information is assigned to a button of “1,” and a function of displaying a comment list is assigned to a button of “2.”

FIG. 9 is a diagram showing another example when operation content assigned to a button of the input unit 31 of the mobile phone 30 is displayed on a screen in association with the button.

Here, in terms of functions assigned to the arrow-keypad buttons, text that describes what function is assigned to which key of the arrow-keypad buttons is displayed as indicated by reference numerals 9a and 9b. Functions assigned to the numeric keypad are displayed as in FIG. 8 (reference numeral 9c).

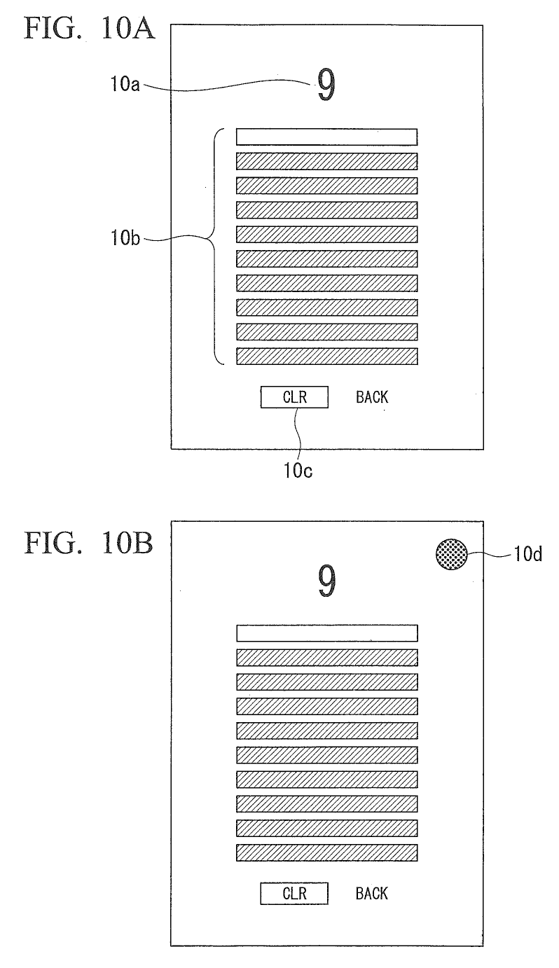

FIGS. 10A and 10B are diagrams showing examples of screens when operation content is input to change the sound volume in the mobile phone 30 or the user terminal 50.

In FIG. 10A, the magnitude of the sound volume is displayed as a character (reference numeral 10a) and displayed as an image (reference numeral 10b). A sound volume adjustment screen of FIG. 10A is displayed if a key for turning up or down the sound volume is pressed. If the key corresponding to the turning up or down of the sound volume is pressed while this screen is displayed, operation information indicating a state in which the key is pressed is generated. If no sound volume operation is performed for a fixed time (for example, 1 second) after the sound volume adjustment screen is displayed, the sound volume adjustment screen is closed and no longer displayed. When a CLR button indicated by reference numeral 10c is pressed, the sound volume adjustment screen is also closed.

FIG. 10B is a diagram showing the case where a transmission mark (reference numeral 10d) indicating that operation information is being transmitted is further displayed on the screen of FIG. 10A. When the operation information is transmitted, the transmission mark is not displayed after the transmission mark is displayed in any position on the screen for a fixed time. Thereby, it is possible to notify the user of the fact that the operation information has been transmitted.

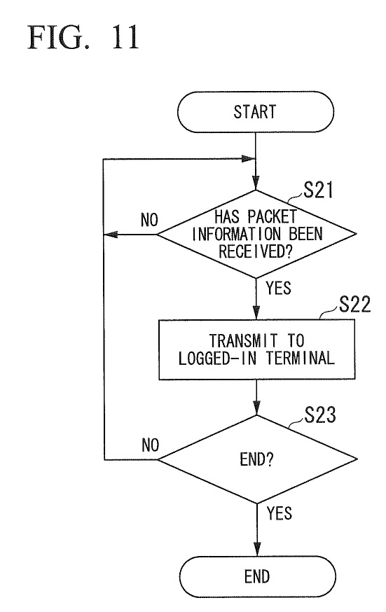

FIG. 11 is a flowchart illustrating an operation of the operation information transmission server 40.

The operation information transmission server 40 determines whether or not packet information has been received from a terminal at fixed intervals (step S21).

Upon receipt of the packet information, the operation information transmission server 40 transmits the received packet information addressed to each currently logged-in terminal in a multicast mode. As a method of transmitting the packet information, the operation information transmission server 40 may transmit the packet information to the content server and the content server 20 may transmit the packet information addressed to each currently logged-in terminal (step S22).

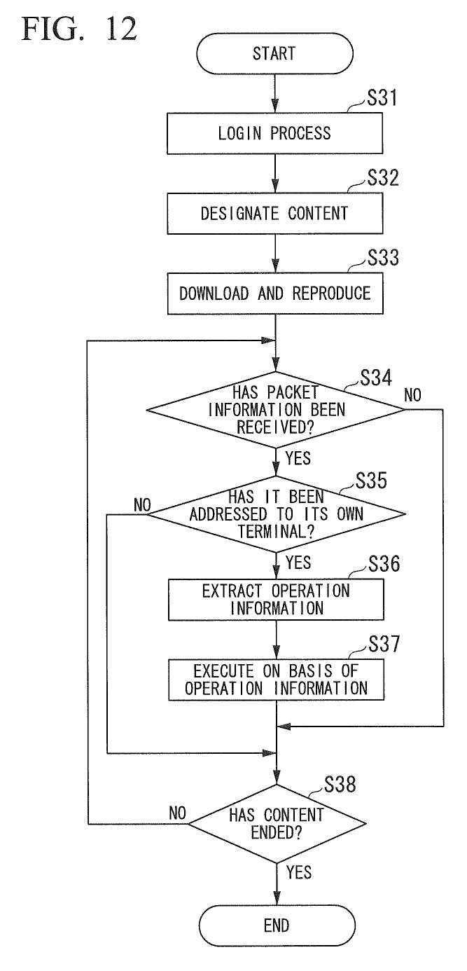

FIG. 12 is a flowchart illustrating an operation of the user terminal 50. The user terminal 50 performs a login process when accessing the content server 20 according to an instruction from the user (step S31). Here, a screen to which a login ID and a password are input is displayed on the output unit 54. If the user inputs the login ID and the password via the input unit 53, the user terminal 50 transmits the login ID and the password to the content server 20 and receives an authentication result. If the login ID and the password are consistent with those pre-registered by the user, the authentication is established and information of a screen for selecting content to be watched is distributed from the content server 20. If the user designates content of a target to be watched via the input unit 53 in the content selection screen (step S32), the user terminal 50 transmits a content ID corresponding to the designated content to the content server 20. Accordingly, content corresponding to the content ID and an operation information transmission program are downloaded to the user terminal 50, the content is played, and the operation information transmission program is executed (step S33).

If the operation information transmission program is executed, the user terminal 50 determines whether or not packet information has been received (step S34). If the packet information has been received, the control unit 52 determines whether or not the packet information is addressed to its own terminal by referring to destination information. If the packet information is not addressed to its own terminal, the received packet information is discarded. If the packet information is addressed to its own terminal, the operation information included in the received packet information is extracted (step S36). If the operation information is extracted, the control unit 52 executes an operation corresponding to the operation information (step S37).

On the other hand, if no command is received, if the received packet information is not addressed to its own terminal, or if the execution of the operation information has ended, the control unit 52 determines whether or not the playing of content has ended (step S38). The process proceeds to step S34 if the playing of content has not ended and an output of the content ends if the playing of content has ended.

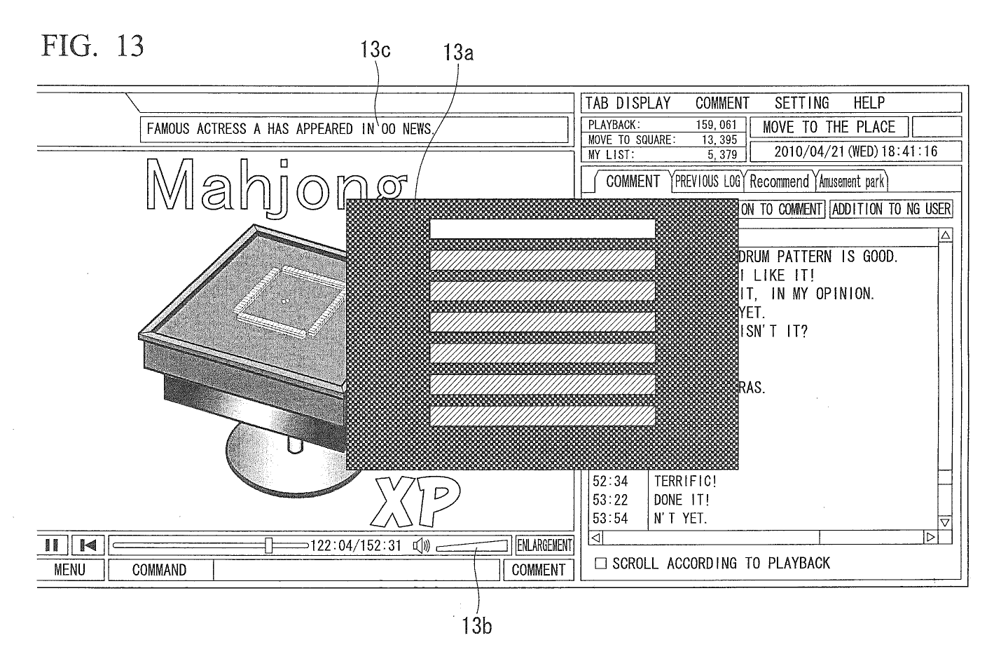

FIG. 13 is a diagram showing an example of content displayed on the screen of the user terminal 50 of a transmission destination when operation information has been received. In this drawing, the case where operation content for turning up or down a sound volume is an example of operation information is shown. Upon receipt of the operation information for performing a sound volume adjustment operation, the user terminal 50 displays a sound volume adjustment screen as a pop-up menu, so that an image corresponding to a sound volume designated by the operation information is displayed and a sound output from the output unit 54 is changed to be set to a sound volume designated by the operation information. Because a screen corresponding to the received operation content is displayed in the user terminal 50 of the transmission destination as described above, it is possible to recognize what operation has been performed.

Here, if the sound volume is changed, the sound volume of the user terminal 50 may be adjusted and changed, or the sound volume of a player (reference numeral 13b) may be adjusted and changed.

As a method of displaying the operation information, content of the operation information may be displayed in text in an information display field displayed around a content display screen as shown in reference numeral 13c. Either or both of the operation information display using the information display field and the pop-up display may be performed.

Upon receipt of the operation information, content of the operation information is displayed in text, or an alarm sound is output, along with a selection button for selecting whether or not to execute the received operation information. The user of the user terminal 50 may select whether or not to execute the received operation information.

In the above-described embodiment, the operation information transmission program includes both of a function of transmitting packet information (the function of the mobile phone 30 described above) and a function of receiving and executing the packet information (the function of the user terminal 50 described above), thereby implementing both of the functions in one terminal. Here, in order to implement either the function of transmitting the packet information or the function of receiving and executing the packet information, the user may designate one or the other and execute a program. Thereby, it is possible to properly use only one of the function of transmitting the packet information and the function of receiving and executing the packet information.

Although the mobile phone 30 operates the user terminal 50 remotely in the above-described embodiment, the user terminal 50 may remotely operate the mobile phone 30 or a remote operation may be performed between the user terminals 50 or between the mobile phones 30. It is preferable that the user terminal 50 be a device having a communication function of establishing a connection to a network and a function of executing the operation information transmission program. The user terminal 50 may be a digital television (TV), a game device, or the like rather than the computer device.

If the user recognizes a user ID of a user of an acquaintance or information capable of specifying the user ID of the acquaintance as destination information, the operation information may be transmitted by designating the user of the acquaintance as a transmission destination. Thereby, it is possible to perform communication with operation content between users while content is watched.

Here, if a user of a transmission source is different from a user of a transmission destination, or if the mobile phone 30 or the user terminal 50 of the transmission destination has received operation information transmitted from another user, a screen to which an instruction of whether or not to execute the received operation information is input may be displayed. The user of the transmission destination selects whether or not to execute the operation information and inputs its instruction while viewing the screen. Thereby, it is possible to execute the operation information according to the instruction from the user of the transmission destination and prevent the operation information from being executed disadvantageously or at an undesired timing.

In the above-described embodiment, the case where the user terminal 50 has executed packet information will be described.

### (1) Switching of Content

An example in which the mobile phone 30 plays content A and the user terminal 50 plays content B will be described. First, the mobile phone 30 transmits operation information for switching content being played in another terminal (the user terminal 50) to other content to the user terminal 50 via the information transmission server 40 according to an operation of the user. The operation information includes a content ID indicating the other content (the content A). Upon receipt of the operation information, the user terminal 50 sends a distribution request by transmitting the content ID indicating the content A included in the operation information to the content server 20. The content server 20 transmits data of the content A to the user terminal 50 according to the distribution request. The user terminal 50 receives and plays the content A distributed from the content server 20. Thereby, the user terminal 50 can play the different content A by switching according to an instruction from the mobile phone 30 even when the content B is being played.

### (2) Volume Operation

Upon receipt of operation information for turning up or down a sound volume of content from the mobile phone 30, the user terminal 50 turns up or down the sound volume of a sound of the content being played according to the operation information. Thereby, it is possible to remotely adjust the sound volume.

### (3) Comment Input

Upon receipt of operation information for inputting a comment from the mobile phone 30, the user terminal 50 designates the content ID of content being played and transmits the comment to the content server. Thereby, it is possible to transmit the comment by setting the user ID of the user terminal 50 as the transmission source. For example, if the user IDs of the mobile phone 30 and the user terminal 50 are different, the user can select which ID is set as the transmission source.

### (4) Operation of Game

If content being watched on the user terminal 50 is a game, operation information for operating the game is transmitted from the mobile phone 30 to the user terminal 50. Thereby, for example, if the user terminal 50 needs to vertically or horizontally move a character within the game, the character in the user terminal 50 can be operated through the mobile phone 30.

### (5) Quiz Answer

If content being watched on the user terminal 50 is a quiz, an answer to the quiz is input from the mobile phone 30 and transmitted to the user terminal 50 as operation information. The user terminal 50 receives the operation information, and transmits the operation information as the answer to the content server 20 along with its own login ID. Thereby, it is possible to answer using the user ID of the user terminal 50 while the mobile phone 30 is operated.

Next, a second embodiment will be described.

While the case where the mobile phone 30 transmits packet information has been described in the first embodiment, the case where the distributor terminal 10 transmits packet information will be described in this embodiment. Because other functions and configurations are the same as in the first embodiment, a description thereof is omitted here.

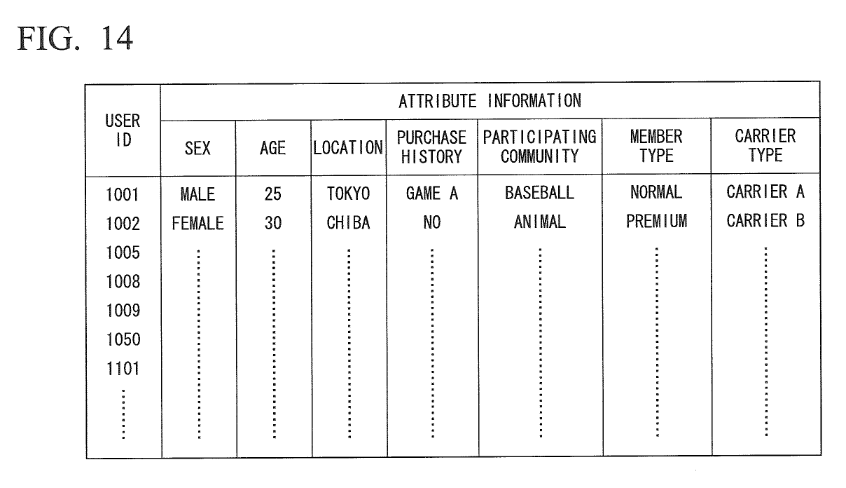

In this embodiment, the storage unit 43 of the operation information transmission server 40 associates a user ID with attribute information and stores a result of association as user registration information. FIG. 14 is a diagram showing an example of the user registration information stored in the storage unit 43.

The user ID is information for identifying a user using a terminal (the mobile phone 30 or the user terminal 50) and is information to be used when a login is performed. The attribute information is information stored in association with the user ID, and indicates an attribute of a user. Here, the attribute information is the sex of the user, the age of the user, the location of the user, the purchase history of a user, i.e., the history of commercial products that the user has purchased in an Internet shopping site related to the operation information transmission system 1, the participating community which indicates a community in which the user has participated in the operation information transmission system 1, the member type of a user indicating whether a member using the content server 20 is a normal member or a premium member capable of receiving more added-value services, the carrier type of a user indicating a carrier of the mobile phone 30 used by the user when the terminal is the mobile phone 30, and the like.

The input unit 160 of the distributor terminal 10 inputs an instruction for designating an attribute of the user from a provider for providing content. The attribute of the user is information corresponding to any item included in the attribute information of FIG. 10. For example, the location can be designated as “Tokyo” or the like.

In this embodiment, if an attribute from the input unit 160 of the distributor terminal 10 is designated during the distribution of content and the operation information is input, the distributor terminal 10 generates packet information from the designated attribute and the operation information and transmits the packet information to the operation information transmission server 40. Upon receipt of the packet information, the operation information transmission server 40 distributes the packet information to each terminal in a multicast mode. The terminal receiving the packet information determines whether or not the attribute information included in the packet information is consistent with its own set attribute, extracts the operation information if the attribute information is consistent with the set attribute as in the above-described embodiment, and performs a control operation corresponding to the operation information. Here, it is preferable that its own attribute be pre-stored within its own terminal.

In this embodiment, transmission source information indicating that the transmission source is the distributor terminal 10 may be included in the packet information to be transmitted.

Here, after a specific community is designated as destination information, the operation information may be transmitted. For example, in terms of an item of “Participating Community” in the attribute information shown in FIG. 14, a user ID belonging to the designated community is extracted and the operation information is distributed to the mobile phone 30 or the user terminal 50 corresponding to the user ID. In addition to using the attribute information, for each community, the community ID, the name of the community, the user ID of a user participating in the community, and information for identifying whether or not the participation in the community is based on an approval system may be associated and stored as a community table. After the user ID of the user participating in the designated community is specified by referring to the community table, the operation information may be distributed.

According to the above-described first or second embodiment, if the operation information and the attribute are input from the distributor terminal 10 during the playing of content, the operation information and the attribute can be distributed as packet information to another terminal according to the input, thereby causing the terminal to perform an operation corresponding to the packet information. Thereby, it is possible to remotely execute various operations in real time during the playing of content.

For example, if packet information is distributed as an instruction for muting the sound volume for a fixed time for a user for which the location of the attribute information is “Tokyo,” a sound of content is not output only for a predetermined duration in a terminal of the user for which the location of the attribute information is “Tokyo.” For example, if the distributor distributes content of a quiz, it is possible to transfer a hint in a sound to only users for which the location of the attribute information is different from “Tokyo,” and improve entertainment.

Next, a third embodiment will be described.

While packet information is distributed to other terminals and executed in real time every time an operation is input in the first and second embodiments, operation content is temporarily stored and distributed at a certain timing in the third embodiment. Because other functions and configurations are the same as those of the first and second embodiments, a description thereof is omitted here.

In this embodiment, the storage unit 35 of the mobile phone 30 stores operation content. For example, the storage unit 35 stores view history information indicating a history of content played in its own mobile phone 30.

Every time an instruction for selecting content is input from the input unit 31, the transmission unit 32 of the mobile phone 30 stores a selected content ID in the storage unit 35, reads view history information stored in the storage unit 35 if a view history transmission instruction is input from the user, generates packet information in which the view history information is set as operation information, and transmits the packet information to the operation information transmission server 40.

Through the configuration as described above, the mobile phone 30 plays selected content every time the content is selected, and stores a result of selection in the storage unit 35 as a view history. This is transmitted as packet information from the mobile phone 30 to the user terminal 50, so that the user terminal 50 can specify a history of content watched in the mobile phone 30. Thereby, because the user can select and watch content in the user terminal 50 among pieces of content watched in the mobile phone 30 when watching content by operating the user terminal 50, it is possible to easily specify and watch content watched in a different terminal. That is, the different terminal can also easily search for and view previously watched content.

In addition, the storage unit 35 may store a continuous operation such as watching of other content after the sound volume is turned down in one operation history in addition to storing the view history. Thereby, it is also possible to transmit stored operation information to the other terminal at an arbitrary timing.

Next, a fourth embodiment will be described.

While the case where packet information is distributed to another terminal and executed there has been described in the first to third embodiments, the case where packet information is transmitted from the distributor terminal 10 will be described in this embodiment. Because other functions and configurations are the same as those of the first to third embodiments, a description thereof is omitted here.

Here, first, a screen displayed on the mobile phone 30 or the user terminal 50 will be described.

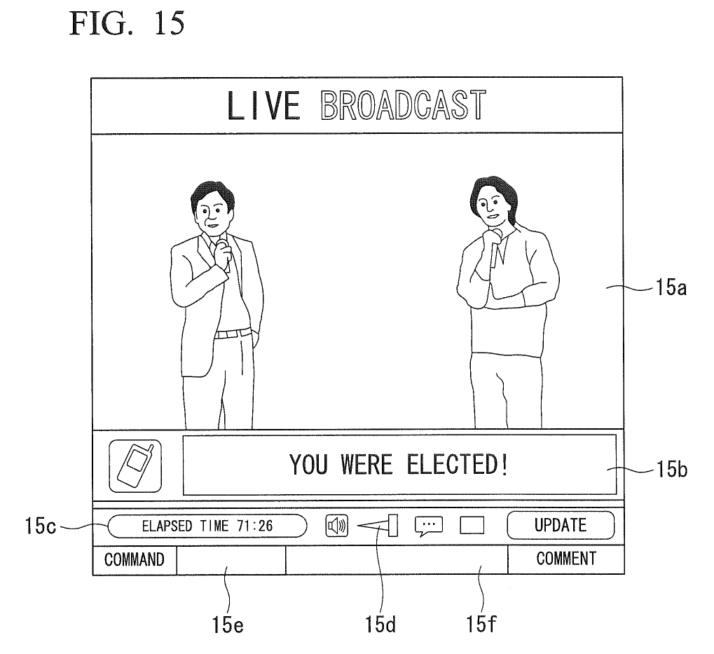

FIG. 15 is a diagram showing an example of a screen when content is displayed on the screen of the mobile phone 30 or the user terminal 50. Here, the case where the distributor distributes a video or a sound shot by the camera from the distributor terminal 10 to the content server 20 in real time, and the content of the video or the sound is distributed to the mobile phone 30 or the user terminal 50 will be described.

When the content is displayed on the mobile phone 30 or the user terminal 50, a video of content is displayed in a content display area (reference numeral 15a) on its display screen, a message distributed from the distributor terminal 10 is displayed in a display field (reference numeral 15b), and an elapsed time after content playing is started is displayed in an elapsed-time display field (reference numeral 15c). In addition, a sound volume adjustment operating element (reference numeral 15d) for changing a sound volume in a player, a command input field (reference numeral 15e) for inputting a command, and an input field (reference numeral 15f) for inputting a comment are displayed.

Next, content in this drawing will be described. In the content of this drawing, the user of the mobile phone 30 can join voice communication in content distributed by the distributor terminal 10. Specifically, a communication device capable of voice communication is provided within a studio where a video is shot by the camera 110 of the distributor terminal 10, and the communication device performs voice communication with the user of the mobile phone 30. Thereby, while content is distributed in real time, a distributor within the studio appearing in the content and the user of the mobile phone 30 watching the content can perform voice communication. Further, as the content, content of the voice communication is distributed to the mobile phone 30 or the user terminal 50. Thereby, the user herself/himself can join the content by voice while watching the content on the user terminal 50. The user can directly talk to the distributor.

Here, it is possible to accept and elect those who wish to join the content among users of a plurality of mobile phones 30 and only the elected users can be permitted to join the content, thereby performing voice communication. In this case, the distributor terminal 10 transmits a message “You were elected!” to the user terminal 50 of the elected user via the content server 20.

Next, functions of this embodiment will be described.

The storage unit 43 of the operation information transmission server 40 associates and stores transmission source identification information used when a first terminal device performs voice communication and transmission destination information, which is a destination to which transmission is performed by specifying a second terminal device owned by a user using the first terminal device. Specifically, a phone number assigned to the mobile phone 30 is set as transmission source identification information, and an Internet protocol (IP) address assigned to the user terminal 50 owned by the user using the mobile phone 30 is associated and stored as transmission destination information. The information may be registered for the user when the user is registered.

The receiving unit 41 acquires the transmission source identification information of the mobile phone 30 from the mobile phone 30 or the distributor terminal 10. For example, the transmission source identification information can be acquired by receiving the phone number of the transmission source reported from the mobile phone 30 to the operation information transmission server 40 using a notification function or by receiving a phone number of the elected person input by the distributor from the distributor terminal 10.

The control unit 44 refers to the storage unit 43 by acquiring the transmission source identification information and reads transmission destination information corresponding to the transmission source identification information, and the transmission unit 42 transmits various data to the user terminal 50 according to the read transmission destination information.

In the configuration as described above, the distributor performs election from among those who wish to join the content, for example, determines one user as an elected person, and inputs an instruction for transmitting a message “You were elected!” addressed to the elected person to the distributor terminal 10. According to this input, the distributor terminal 10 transmits data including the message “You were elected!” addressed to the elected person and a phone number through which voice communication with the distributor can be performed to the content server 20. Here, the control unit 44 reads transmission destination information of the user terminal 50 of the elected person and sends an instruction for transmitting data by setting the read transmission destination information as a destination. The content server 20 transmits the message and the phone number to the user terminal 50 corresponding to the transmission destination information according to the data transmission instruction. Alternatively, the message, the phone number, and a user ID of the elected person are transmitted from the distributor terminal 10 to the content server 20, and stored in the content server 20. Here, an election flag indicating the election in the user ID, the user ID, the message, and the phone number are associated and stored as election result information. If the mobile phone 30 has transmitted an inquiry of whether or not there is information regarding the election result at a fixed interval to the content server 20 and acquired the election flag, the phone number, and the message, the fact that a phone call is sent to the phone number is displayed on the output unit 33 of the mobile phone 30. Thereby, for only the user terminal 50 consistent with the transmission destination information, the message is displayed in the display field indicated by reference numeral 15b, and the phone number is displayed.

The user knowing the election continuously sends an outgoing call from the mobile phone 30 to the phone number, thereby performing voice communication with the distributor and joining the content.

Here, a sound output as content is likely to be detected by a microphone of the mobile phone 30 if the voice communication from the mobile phone 30 is performed in the vicinity thereof while content is watched on the user terminal 50. Thus, the distributor inputs an instruction for turning down a sound volume of the user terminal 50 after the above-described message has been transmitted or simultaneously. If the instruction is input, the distributor terminal 10 transmits its packet information addressed to the user terminal 50. Thereby, when the user performs content distribution to join content by use of voice communication, it is possible to prevent a sound detected by the mobile phone 30 from the sound of the content from being mixed into content and distributed to the mobile phone 30 or the user terminal 50 of another user as noise.

When an outgoing call is sent from the elected mobile phone 30, a voice communication device having a function of switching equipment receives the outgoing call, and a phone number reported upon reception may be reported to the content server 20 or the operation information transmission server 40.

Although the case where the control unit 44 transmits data by setting the user terminal 50 as the transmission destination has been described in this embodiment, transmission may be performed by setting the mobile phone 30 as the transmission destination. In this case, for example, a transmission source identification number (for example, an IP address) of the user terminal 50 and transmission destination information of the mobile phone 30 for performing voice communication using an Internet line are associated and stored. The control unit 44 can transmit data by acquiring an IP address reported when access from the user terminal 50 is performed and reading transmission destination information corresponding to the IP address from the storage unit 43.

Next, a fifth embodiment will be described.

In this embodiment, the case where a remote control function from the mobile phone 30 starts up will be described. Because this embodiment is the same as the above-described first to fourth embodiments except for the function of this embodiment, a description thereof is omitted here.

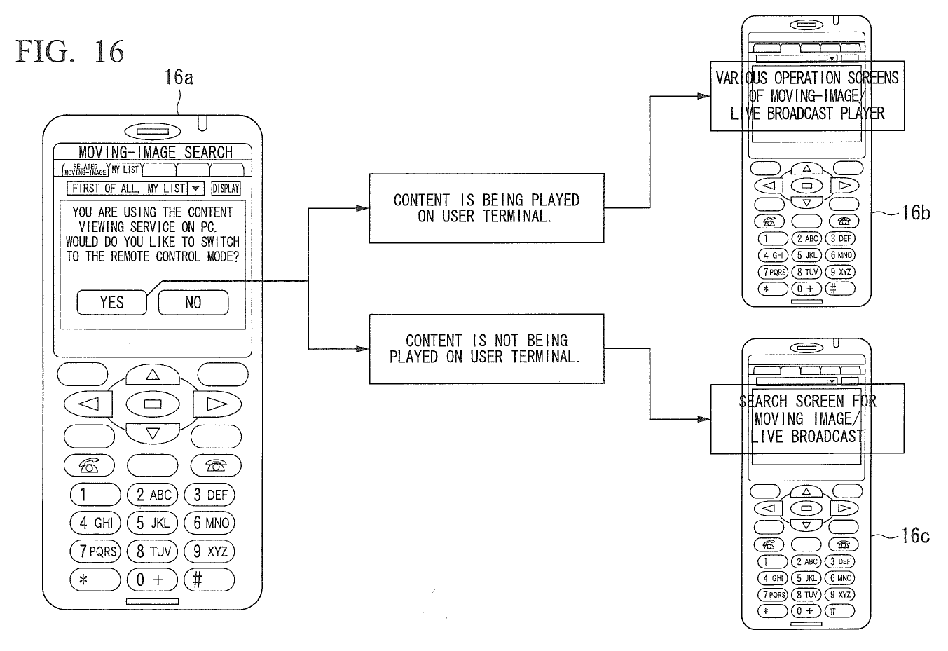

FIG. 16 is a diagram illustrating a function of the mobile phone 30.

When an application of the above-described content viewing service is started up by the user terminal 50, a message “You are using the content viewing service on PC. Would do you like to switch to the remote control mode?” and options of “Yes” and “No” are displayed if the application of the above-described content viewing service starts up in the mobile phone 30 (reference numeral 16a). Here, if “Yes” is clicked, various operation screens of a player, which plays content, are displayed when the content is played in the application of the content viewing service in the user terminal 50 (reference numeral 16b). On the other hand, in the user terminal 50, a menu screen for selecting content of a playing target is displayed when the content is not played (reference numeral 16c). As described above, it is possible to switch and display an operation screen according to a use state of the user terminal 50.

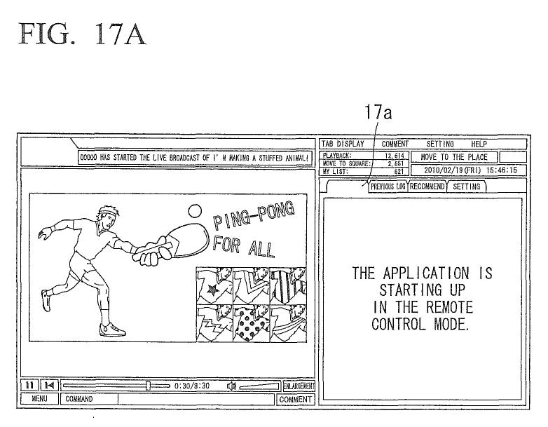

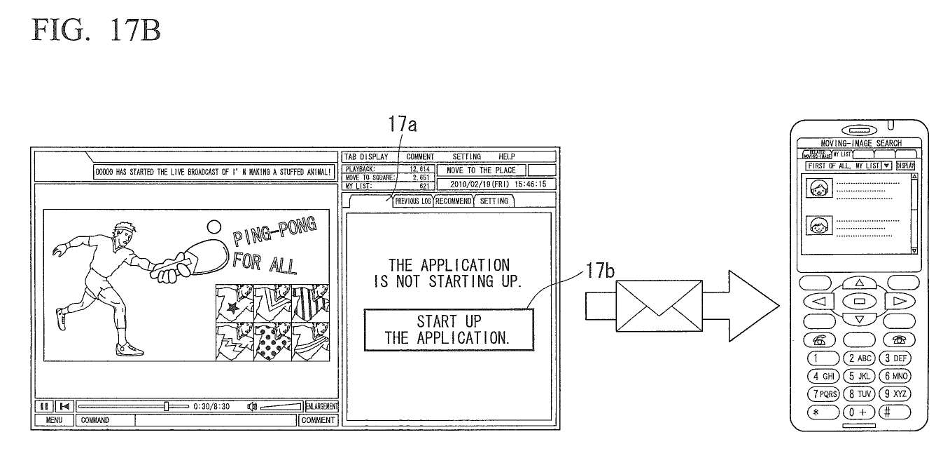

FIGS. 17A and 17B are diagrams showing examples of screens displayed on the user terminal 50. FIG. 17A shows an example of a screen displayed on the user terminal 50 when an application of a content viewing service starts up in the mobile phone 30. A plurality of tabs for selecting a function are displayed on a part of the screen if the content viewing service starts up in the user terminal 50, and a message “The application is starting up in the remote control mode” is displayed if a tab (reference numeral 17a) related to the remote control among the plurality of tabs is clicked. Thereby, the mobile phone 30 can recognize that the remote control function is valid.

FIG. 17B shows an example of a screen displayed on the user terminal 50 when the application of the content viewing service does not start up in the mobile phone 30. If a tab related to the remote control mode of the screen of the user terminal 50 is clicked, a message “The application is not starting up” and a button (reference numeral 17b) for an instruction for starting up the application are displayed. If the button for starting up the application is clicked, the operation information transmission server 40 transmits an electronic mail including an application start-up instruction addressed to the mobile phone 30. It is preferable that the transmission destination be stored in the storage unit 43 in association with an electronic mail address of the mobile phone 30 in the user terminal 50.

Next, a sixth embodiment will be described.

In this embodiment, the case where the mobile phone 30 transmits packet information without designating destination information will be described. Because this embodiment is the same as the above-described first to fifth embodiments except for a function in this embodiment, a description thereof is omitted here.

In this embodiment, the transmission unit 32 of the mobile phone 30 transmits operation content and its own terminal identification information of the mobile phone 30 as packet information to the operation information transmission server 40. It is preferable that the terminal identification information be information for identifying the mobile phone 30.

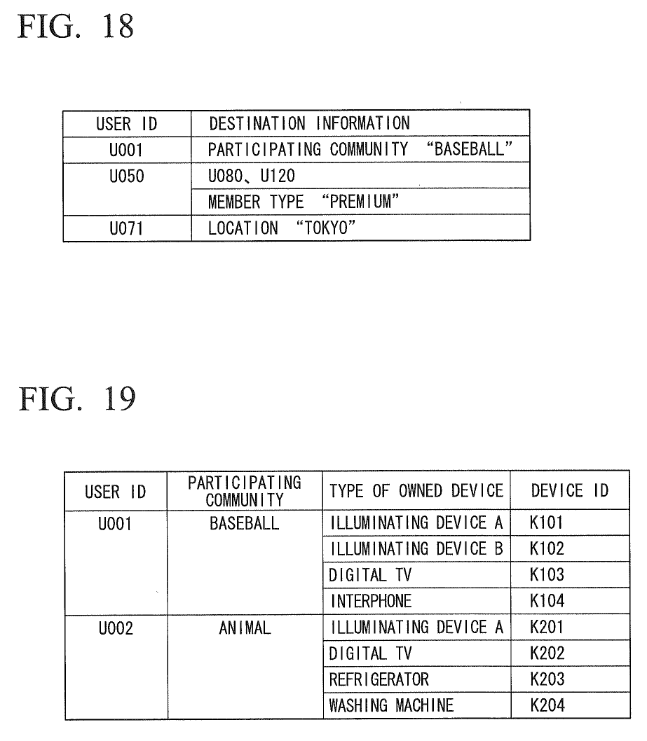

The storage unit 43 of the operation information transmission server 40 associates and stores the terminal identification information of the mobile phone 30 and the destination information indicating a target to which operation information is transmitted. FIG. 18 is a diagram showing an example of information stored in the storage unit 43 according to this embodiment. The destination information to be used here can be designated as one or more transmission targets of user terminals 50. For example, terminal identification information for identifying the user terminal 50 or attribute information of a user of the user terminal 50 can be used.

The transmission unit 42 of the operation information transmission server 40 extracts terminal identification information included in the packet information transmitted from the mobile phone 30, reads destination information corresponding to the terminal identification information from the storage unit 43, and transmits the packet information to the user terminal 50 corresponding to the read destination information.

According to this configuration, the mobile phone 30 receives an input of operation information, and transmits the operation information as packet information along with its own terminal identification information. Upon receipt of the packet information, the operation information transmission server 40 transmits the operation information to the user terminal 50 according to destination information corresponding to terminal identification information included in the packet information. Here, for example, if a participating community “Baseball” is designated as the destination information, a user ID of a user participating in the community “Baseball” is read by referring to user registration information stored in the storage unit 43, and packet information is transmitted to the user terminal 50 corresponding to the user ID.

According to this embodiment, the mobile phone 30 can transmit packet information to the user terminal 50 corresponding to its own terminal identification information by merely transmitting its own terminal identification information along with operation content. Because the operation information transmission server 40 transmits the packet information to the user terminal 50 by referring to the destination information stored in the storage unit 43, a service provider side can determine a destination according to service content.

The destination information stored in the storage unit 43 may be the terminal identification information for designating a target of a transmission destination rather than the attribute information, and may be used to designate the user terminal 50 playing the same content as content played in the mobile phone 30. Here, the transmission source of the packet information may be the user terminal 50 and the transmission destination may be the mobile phone 30.

Next, a seventh embodiment will be described.

In this embodiment, the case where a device that executes packet information transmitted from the operation information transmission server 40 is a device other than the mobile phone 30 or the user terminal 50 will be described.

Here, an information home electric appliance connectable to a network is installed in the user's home, and has a function of receiving packet information transmitted from the operation information transmission server 40 via the network and executing an operation corresponding to operation information.

FIG. 19 is a diagram showing an example of user registration information stored in the storage unit 43.

The user registration information is associated with a user ID, a participating community, an owned device, and a device ID.

The user ID is information for identifying a user using a terminal (the mobile phone 30 or the user terminal 50), and is information to be used when a login is performed. The participating community is information indicating a community in which the user participates in the operation information transmission system 1.

A type of owned device is information indicating a type of information home electric appliance owned by the user. Here, for example, an illuminating device A is an illuminating device capable of adjusting illuminance. The device ID is information for identifying each owned device owned by each user. It is possible to uniquely specify an owned device connected to a network by the device ID.

In this embodiment, the mobile phone 30 transmits packet information including operation content input from the user, an owned device type designating a type of information home electric appliance, which is an operation target, and destination information to the operation information transmission server 40.

The transmission unit 42 of the operation information transmission server 40 extracts the owned device type included in the packet information received from the mobile phone 30, reads a device ID of an information home electric appliance corresponding to the owned device type, and transmits the packet information by setting the read device ID as a transmission target.

According to this embodiment, for example, a user operates the mobile phone 30 at an outside location and inputs operation content in which a switch is turned off by designating the illuminating device A, thereby turning off a switch of the illuminating device A installed in the home.

In this embodiment, it is also possible to consider the user terminal 50 playing content designated by the mobile phone 30 of the transmission source as a transmission target. For example, the operation information transmission server 40 acquires the content ID along with the packet information from the mobile phone 30. The acquisition of the content ID may be designated from the mobile phone 30. The ID of content played by the mobile phone 30 may be specified on the basis of information of a session in which the mobile phone 30 and the content server 20 are connected. The operation information transmission server 40 extracts the user terminal 50 playing the same content on the basis of the content ID, specifies a device ID corresponding to an owned device type consistent with packet information among owned device types associated with the user ID corresponding to the user terminal 50, and transmits packet information by setting the device ID as destination information.

For example, when content of a drama of a live broadcast is played, the user of the mobile phone 30 sets a user playing the same content to a target according to a scene in which the interphone rings in the drama, inputs the owned device type “interphone” and the operation content “The interphone rings,” and transmits them as packet information. Thereby, the operation information transmission server 40 specifies the user terminal 50 playing the same content, reads a device ID corresponding to the owned device type of “Interphone” from among pieces of the content, and transmits the packet information, which is the operation content “The interphone rings,” by setting the device ID as destination information. Thereby, it is possible to increase the realistic sensations of content because the interphone of one's home actually rings for the user of the user terminal 50 according to the scene in which the interphone rings. According to the content scene in which illumination is turned off, it is also possible to turn off an illuminating device of the user playing the same content.

The mobile phone 30 transmits packet information by including its own terminal identification information instead of destination information, and the side of the operation information transmission server 40 may specify the destination information corresponding to the terminal identification information of the mobile phone 30 as described in the above-described embodiment. For example, if the participating community is designated as the destination information, a device ID associated with a device consistent with a type of information home electric appliance of an operation target among users participating in the participating community is read, and packet information may be transmitted by setting the device ID as a transmission target.

Next, an eighth embodiment will be described.

In this embodiment, the case where there are a normal member using a content distribution service by the content server 20 at no fee and a premium member using the content distribution service at a fee as the member types as described above will be described. In addition, the case where packet information including operation information for performing a process of switching the member type is transmitted to the mobile phone 30 according to a difference in behavior caused by a difference between the member types as described above will be described. Here, configurations and functions different from those of the above-described embodiments will be described.

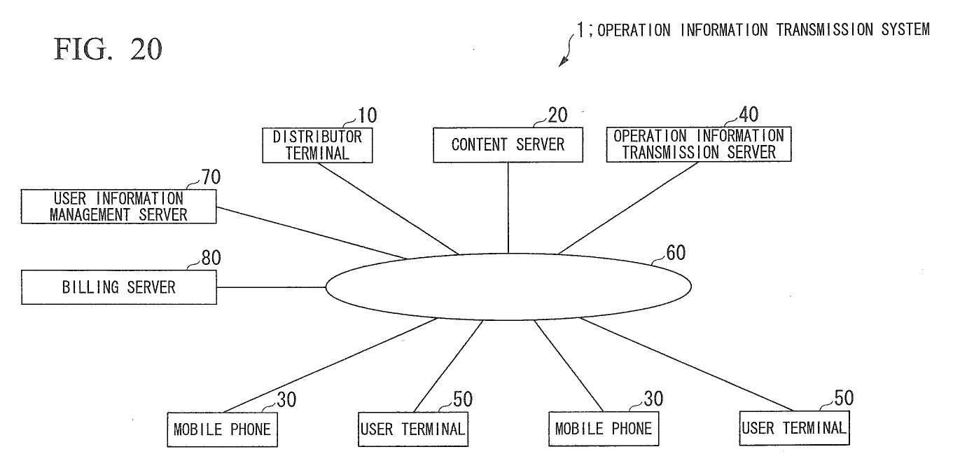

FIG. 20 is a diagram showing a configuration of the operation information transmission system 1 of this embodiment. Here, the user terminal 50 will be described as an example of a first terminal device, and the mobile phone 30 will be described as an example of a second terminal device. The operation information transmission system 1 of this embodiment further includes a user information management server 70 and a billing server 80.

The user information management server 70 manages access of the mobile phone 30 or the user terminal 50 connected to the content server 20. The user information management server 70 stores user registration information including information indicating a member type of a user shown in FIG. 14 in its own storage area. In addition, upon receipt of a switching request of the member type from the terminal, the user information management server 70 communicates with the mobile phone 30 or the billing server 80, and performs a switching process of changing the member type of the user.

The billing server 80 is a server of a service provider, which provides a communication service of the mobile phone 30. The billing server 80 serves as an agency to charge a fee to the mobile phone 30 from a content distribution service provided by the content server 20, and provides a billing agency service, which sends a bill to the user together with a communication fee of the mobile phone 30. That is, the billing server 80 is a server of a mobile carrier, and performs billing related to service use in the mobile phone. Here, the billing server 80 communicates with the mobile phone 30 or the user information management server 70, and performs an agency process of charging a fee to a certain premium member at a fee if the member type of the user is switched from normal to premium.

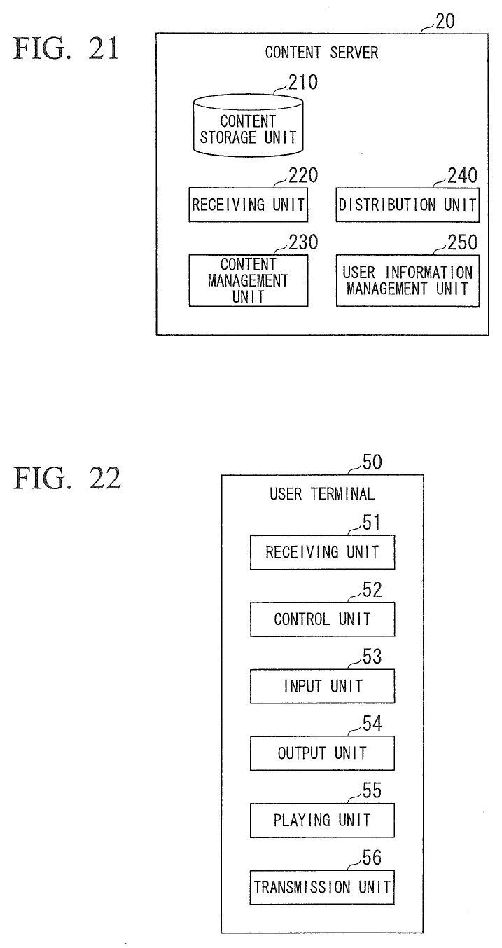

The content server 20 of this embodiment includes a user information management unit 250 in addition to the same functional units as those of the above-described embodiments. FIG. 21 is a diagram showing a configuration of the content server 20.

The user information management unit 250 counts and detects the number of terminals (the number of sessions) to which the content server 20 distributes content in real time. Here, in order to prevent the overload of the content server 20 or the network 60, a control operation is performed so that the number of terminals connected to the content server 20 is equal to or less than a fixed number (for example, 1000). That is, if the content server 20 receives content distribution requests from terminals of which the number exceeds the fixed number, the user information management unit 250 rejects the content distribution for the number of terminals by which it exceeds the fixed number. The fixed number as described above is stored in a storage area of the user information management unit 250 and can be changed as necessary. The user information management unit 250 receives user registration information by communicating with the user information management server 70, and stores the received user registration information in its own storage area.

Here, if the number of currently connected terminals exceeds a fixed number, the user information management unit 250 performs a control operation to distribute content to a terminal of a user who is a premium member more preferentially than a terminal of a user whose member type is normal. Specifically, upon receipt of a content distribution request, the user information management unit 250 determines whether or not the number of currently connected terminals is equal to or less than the fixed number. If the number of currently connected terminals is determined to be equal to or less than the fixed number, the distribution unit 240 starts to distribute content to the terminal transmitting the distribution request. On the other hand, if the number of currently connected terminals is determined to exceed the fixed number, the user information management unit 250 determines a member type of a user of a terminal transmitting the distribution request.

Here, if the user information management unit 250 determines that the member type of the user is normal, the distribution is not performed. On the other hand, if the member type of the user is determined to be premium, it is determined whether or not there are currently connected terminals of normal members. If it is determined that there are the currently connected terminals of the normal members, priority processing for stopping distribution to currently connected terminals of the normal members of which the number is the same as the number of terminals of premium members transmitting distribution requests and starting distribution to the terminals of the premium members by establishing a connection to the terminals of the premium members is performed. If content distribution requests are further received from terminals of other premium members, the priority processing as described above is performed until there are no more currently connected terminals of normal members. On the other hand, if it is determined that there are no more currently connected terminals of normal members and all the currently connected terminal are terminals of premium members, the distribution for a terminal of a premium member is not performed even when a distribution request is received from the terminal of the premium member.

The distribution unit 240 distributes a result of determination by the user information management unit 250 to the user terminal 50. For example, if the number of connections to the content server 20 exceeds a fixed number and the distribution of content to a terminal of a user has been stopped by determining a member type of the user as the normal type, a stop notification indicating that the content distribution has been stopped is transmitted to the user terminal 50 as a result of determination as described above.

FIG. 22 is a diagram showing a configuration of the user terminal 50. In this embodiment, the user terminal 50 further includes a transmission unit 56.

The transmission unit 56 transmits packet information including operation information for performing an operation of switching the member type according to the determination result transmitted from the content server 20 and destination information for designating the mobile phone 30, which is a transmission target of the operation information among a plurality of mobile phones 30, to the operation information transmission server 40.

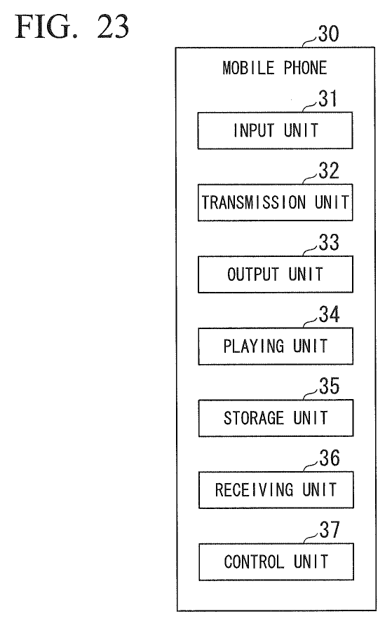

FIG. 23 is a diagram showing a configuration of the mobile phone 30. In this embodiment, the mobile phone 30 further includes a receiving unit 36 and a control unit 37.

The receiving unit 36 receives the packet information transmitted by the transmission unit 42 of the operation information transmission server 40.

On the basis of the operation information included in the packet information received by the receiving unit 36, the control unit 37 is connected to the user information management server 70 and switches the member type of the user.

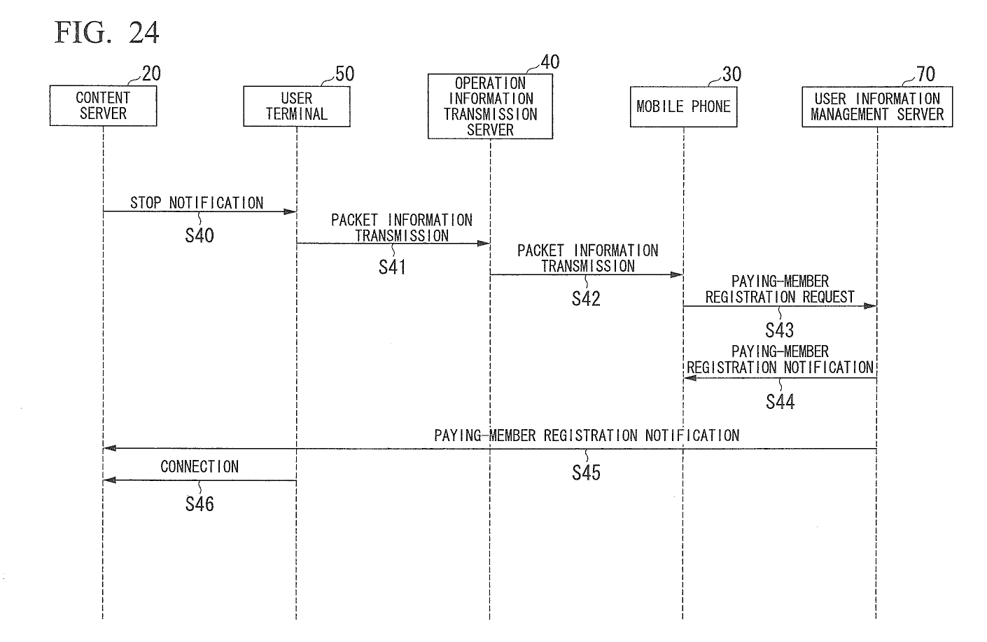

Next, an example of the operation information transmission system 1 of this embodiment will be described. FIG. 24 is a sequence diagram showing the example of the operation information transmission system 1 of this embodiment.

If the content server 20 receives a distribution request of content from a terminal, the user information management unit 250 performs priority processing by determining whether or not the number of currently connected terminals exceeds a fixed number, whether or not a user of a terminal transmitting a distribution request is a premium member, and whether or not there is a terminal of a normal member among currently connected terminals. Here, if it is determined that the number of currently connected terminals exceeds the fixed number, the user of the terminal transmitting the distribution request is the premium member, and there is the currently connected terminal of the normal member, the user information management unit 250 performs the priority processing to start the distribution to a terminal of a premium member by stopping the content distribution to the currently connected terminal of the normal member. If the priority processing is performed, the content server 20 transmits a stop notification to the user terminal 50 of the user for which the distribution has been stopped (step S40).

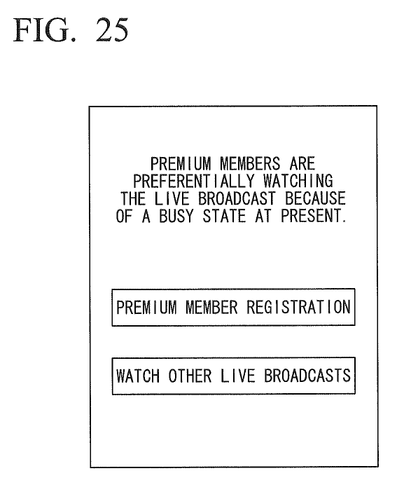

The transmission unit 56 of the user terminal 50 generates packet information including operation information for performing an operation of switching the member type according to the stop notification transmitted from the content server 20 and destination information for designating the mobile phone 30 corresponding to its own user ID among a plurality of mobile phones 30, and transmits the packet information to the operation information transmission server 40 (step S41). Upon receipt of the packet information transmitted from the user terminal 50, the operation information transmission server 40 transmits the packet information to the mobile phone 30 indicated by the destination information included in the received packet information (step S42). If the receiving unit 36 of the mobile phone 30 receives the packet information transmitted from the operation information transmission server 40, the control unit 37 causes the output unit 33 to display a screen for selecting whether or not to perform premium member registration on the basis of the operation information included in the packet information. FIG. 25 is a diagram showing an example of the selection screen as described above. A button for selecting the registration of a premium member and a button for selecting the watching of another live broadcast are displayed on the selection screen.

Here, if the button for selecting the registration of the premium member is pressed, the transmission unit 32 of the mobile phone 30 requests the user information management server 70 to perform the premium member registration of a user (step S43). For example, the user information management server 70 transmits information indicating a connection destination to the billing server 80, which registers the premium member, to the mobile phone 30, and the mobile phone 30 is connected to the billing server 80 on the basis of the information transmitted from the user information management server 70. If the user inputs authentication information indicating a predetermined password for a billing process to the mobile phone 30, the mobile phone 30 transmits the input authentication information to the billing server 80. The billing server 80 performs an authentication process based on the authentication information transmitted from the mobile phone 30, and transmits a billing completion notification to the mobile phone 30 and the user information management server 70 if the authentication is determined to be successful. If the authentication is determined to be unsuccessful, the billing server 80 does not transmit the billing completion notification.

If the billing server 80 charges a fee to the premium member by communicating with the mobile phone 30 and the user information management server 70 and the user information management server 70 receives the billing completion notification from the billing server 80, the member type of the user included in the user registration information stored in its own storage area is updated from normal to premium and stored, and a premium-member registration completion notification is transmitted to the mobile phone 30 and the content server 20 (steps S44 and S45). The mobile phone 30 causes the output unit 33 to display a screen indicating that the premium-member registration has been completed. The user information management unit 250 of the content server 20 updates the member type of the user included in the user registration information stored in its own storage area from normal to premium and stores the updated member type. The user terminal 50 is connected to the content server 20 and transmits a content distribution request to the content server 20 (step S46). Here, because the user of the user terminal 50 is stored in the content server 20 as the premium member, the content server 20 approves a connection without rejecting the content distribution, and distributes content.

Here, although an example in which the content server 20 sends a stop notification to the user terminal 50 and the user terminal 50 generates packet information according to the stop notification has been described, the content server 20 may generate packet information and transmit the generated packet information to the operation information transmission server 40. In this case, the distribution unit 240 of the content server 20 transmits packet information including operation information for performing an operation of switching the member type according to the result of determination by the user information management unit 250 and destination information for designating the mobile phone 30 that is a transmission target of operation information among a plurality of mobile phones 30 to the operation information transmission server 40.

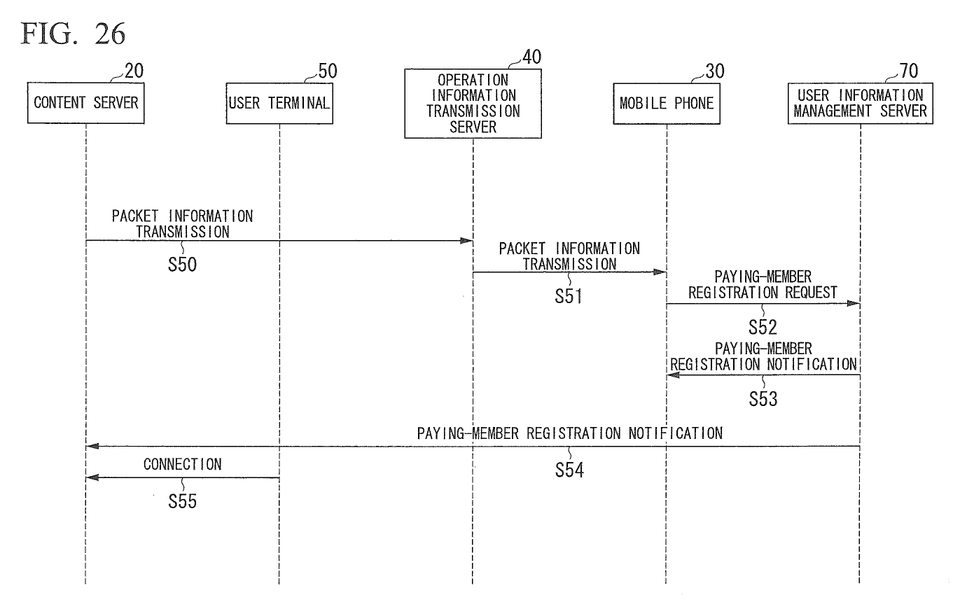

FIG. 26 is a sequence diagram showing an example of the operation information transmission system 1 as described above. Here, if the user information management unit 250 of the content server 20 performs priority processing according to a content distribution request transmitted from a terminal, packet information including destination information for designating the mobile phone 30 corresponding to a user ID for which distribution has been stopped is generated without performing the stop notification and transmitted to the operation information transmission server 40 (step S50). A subsequent process from step S51 to step S55 is the same as the above-described process from step S42 to step S46.

According to the above, when the content distribution request is performed, it is possible to urge the user of the terminal whose member type is normal receiving the stop notification among currently connected terminals to perform the switching to the premium member if the number of terminals for which distribution is performed exceeds a fixed number. Here, there is a problem in that the user desiring to watch content should perform an operation of accessing the user information management server 70 by the user terminal 50, finding a member switching page, sending a switching request, or the like, thereby consuming the time, if the user is the normal member. On the other hand, according to this embodiment, it is possible to easily switch the member type by a remote operation. That is, even when the user of the normal membership desires to receive the distribution of content by switching the member type to premium, it is possible to easily perform an operation of switching the member type using the mobile phone 30 without separately performing the operation of accessing the user information management server 70 by the user terminal 50, finding a member switching page, sending a switching request, or the like. Because the billing server 80 serves as the agency to charge a fee to the premium member when payment is made using the mobile phone 30, the user can easily make the payment. On the other hand, the service provider can also easily charge a fee. Thereby, it is possible to watch content after the premium member is smoothly registered and avoid watching from being abandoned due to complex switching of the member type. It is possible to provide a service to a premium member more preferentially than a normal member.

A process of transmitting operation information or a process of executing packet information may be executed by recording a program for implementing the functions of the mobile phone 30, the operation information transmission server 40, and the user terminal 50 described above on a computer-readable recording medium and causing a computer system to read and execute the program recorded on the recording medium. The “computer system” includes an operating system (OS), and hardware such as peripheral devices.

The “computer system” includes a homepage providing environment (or displaying environment) when the World Wide Web (WWW) system is used.

The “computer readable recording medium” is a portable medium such as a flexible disk, magneto-optical disc, read only memory (ROM) and compact disc-ROM (CD-ROM), and a storage device, such as a hard disk, built in the computer system. Furthermore, the “computer readable recording medium” may also include a medium that dynamically holds a program for a short period of time, such as a communication line when a program is transmitted via a network such as the Internet or a communication line such as a telephone line, and a medium that holds a program for a fixed period of time, such as a volatile memory in a computer system serving as a server or client in the above situation. The program may be one for implementing a part of the above functions, or the above functions may be implemented in combination with a program already recorded on the computer system.

The embodiments of the present invention have been described in detail with reference to the drawings. However, specific configurations are not limited to the embodiments and may include any design in the scope without departing from the subject matter of the present invention.

1. An operation information transmission server for use in an operation information transmission system in which a plurality of terminal devices, a content server which distributes content, and the operation information transmission server are connected via a network, the server comprising:
a first receiving unit which receives packet information, which is transmitted from a first terminal device among the plurality of terminal devices and includes operation information indicating operation content related to an output of content distributed from the content server; and
a second transmission unit which transmits the operation information addressed to a second terminal device which outputs the content on the basis of the operation content indicating the operation information.

2. An operation information transmission system in which a plurality of terminal devices, a content server which distributes content, and an operation information transmission server are connected via a network,
wherein a first terminal device of the plurality of terminal devices includes:
an input unit which receives an input of operation information indicating operation content related to an output of content distributed from the content server; and
a first transmission unit which transmits packet information including the operation information of which the input is received by the input unit to the operation information transmission server,
wherein the operation information transmission server includes:
a first receiving unit which receives the packet information transmitted from the first transmission unit; and
a second transmission unit which transmits the operation information addressed to a second terminal device, and
wherein the second terminal device includes:
a second receiving unit which receives the operation information transmitted from the second transmission unit; and
a control unit which outputs the content on the basis of the operation content indicated by the operation information received by the second receiving unit.

3. The operation information transmission system according to claim 2, wherein the content server which distributes the content is connected to the operation information transmission system,
the content server including a distribution unit which receives operation information and distributes a program and a content for implementing a function of performing an operation corresponding to the operation information according to a request from a terminal device,
the second terminal device including a playing unit, connected to the content server, which plays the content, and
the control unit of the second terminal device outputting the content by executing the program.

4. The operation information transmission system according to claim 2, wherein the first transmission unit of the first terminal device transmits the packet information to the operation information transmission server by generating destination information by use of login information input via the input unit, and
the second transmission unit of the operation information transmission server transmits the operation information to a second terminal device corresponding to the destination information included in the packet information transmitted from the first transmission unit among logged-in second terminal devices in which login information has been input.

5. The operation information transmission system according to claim 2, wherein the input unit of the first terminal device inputs an instruction to the terminal device which designates an attribute of a user from a provider which provides the content, in addition to the operation information,
the first transmission unit of the first terminal device generates destination information for designating a second terminal device corresponding to the attribute input from the input unit as a transmission target, and
the second transmission unit of the operation information transmission server transmits the operation information to the second terminal device of the user corresponding to the attribute according to the destination information in which the second terminal device corresponding to the attribute transmitted from the first terminal device is set as a target.

6. The operation information transmission system according to claim 2, wherein the first terminal device includes a storage unit which stores view history information indicating a history of content played in its own terminal device, and
the first transmission unit of the first terminal device reads the view history information stored in the storage unit when a view history transmission instruction is input from the input unit, generates packet information in which the view history information is set as operation information, and transmits the generated packet information to the operation information transmission server.

7. The operation information transmission system according to claim 2, wherein the operation information transmission server includes:
a storage unit which associates and stores transmission source identification information to be used when the first terminal device performs voice communication and transmission destination information, which is a destination to which transmission is performed by specifying a second terminal device owned by a user using the first terminal device;
a transmission source identification information acquiring unit which acquires the transmission source identification information of the first terminal device from the first terminal device or a terminal device of the provider which provides the content; and
a control unit which refers to the storage unit by acquiring the transmission source identification information, reads transmission destination information corresponding to the transmission source identification information, and transmits the operation information to the second terminal device through the second transmission unit according to the read transmission destination information.

8. The operation information transmission system according to claim 3, wherein the content server includes a determination unit which determines a member type of a user of the first terminal device,
the distribution unit of the content server distributes a determination result of the determination unit to the first terminal device,
the operation information is used to perform an operation of switching the member type according to the determination result transmitted from the content server, and
the first transmission unit of the first terminal device transmits packet information including the operation information and destination information for designating a second terminal device, which is a transmission target of the operation information among the plurality of terminal devices, to the operation information transmission server.

9. The operation information transmission system according to claim 3, wherein the content server includes a determination unit which determines a member type of a user of the first terminal device,
the operation information is used to perform an operation of switching the member type according to the determination result, and
the distribution unit of the content server transmits packet information including the operation information and destination information for designating a second terminal device, which is a transmission target of the operation information among the plurality of terminal devices, to the operation information transmission server.

10. The operation information transmission system according to claim 8, wherein the second receiving unit of the second terminal device receives the packet information transmitted by the second transmission unit of the operation information transmission server, and
the control unit of the second terminal device is connected to a user information management server which switches a member type of the user, according to the packet information received by the second receiving unit.

11. An operation information transmission server for use in an operation information transmission system in which a plurality of terminal devices, a content server which distributes content, and the operation information transmission server are connected via a network and a plurality of terminal devices are connected to the network, the server comprising:
a first receiving unit which receives packet information including operation information, which is input from an input unit of a first terminal device among the plurality of terminal devices and indicates operation content related to an output of content distributed from the content server; and
a second transmission unit which transmits the operation information addressed to a second terminal device which outputs the content on the basis of the operation content indicating the operation information.

12. An operation information transmission method of an operation information transmission server for use in an operation information transmission system in which a plurality of terminal devices, a content server which distributes content, and the operation information transmission server are connected via a network, the method comprising:
receiving, by a first receiving unit, packet information, which is transmitted from a first terminal device among the plurality of terminal devices and includes operation information indicating operation content related to an output of content distributed from the content server; and
transmitting, by a second transmission unit, the operation information addressed to a second terminal device, which outputs the content on the basis of the operation content indicating the operation information.

13. An operation information transmission method for use in an operation information transmission system in which a plurality of terminal devices, a content server which distributes content, and an operation information transmission server are connected via a network, the method comprising:
inputting, by an input unit of a first terminal device of the plurality of terminal devices, operation information indicating operation content related to an output of content transmitted from the content server;
transmitting, by a first transmission unit of the first terminal device, packet information including the operation information input from the input unit to the operation information transmission server;
receiving, by a first receiving unit of the operation information transmission server, the packet information transmitted from the first transmission unit;
transmitting, by a second transmission unit of the operation information transmission server, the operation information addressed to a second terminal device;
receiving, by a second receiving unit of the second terminal device, the operation information transmitted from the second transmission unit; and
outputting, by a control unit of the second terminal device, the content on the basis of the operation content indicated by the operation information received by the second receiving unit.

14. An operation information transmission method of an operation information transmission server for use in an operation information transmission system in which a plurality of terminal devices, a content server which distributes content, and the operation information transmission server are connected via a network and a plurality of terminal devices are connected to the network, the method comprising:
receiving, by a first receiving unit, packet information including operation information, which is input from an input unit of a first terminal device among the plurality of terminal devices and indicates operation content related to an output of content distributed from the content server; and
transmitting, by a second transmission unit, the operation information addressed to a second terminal device, which outputs the content on the basis of the operation content indicating the operation information.
